(19) United States
(12) Patent Application Publication
(10) Pub. No.: US 2006/0185530 A1
(43) Pub. Date: Aug. 24, 2006

(54) Device for distribution of a liquid or viscous product, particularly a cleaning product

(76) Inventors: Jean-Yves Corbin, Thaon (FR); Mathias D'Estais, Cairon (FR); Laurent Clisson, Fontenay-Aux-Roses (FR)

Correspondence Address: IP GROUP OF DLA PIPER RUDNICK GRAY CARY US LLP, 1650 MARKET ST, SUITE 4900, PHILADELPHIA, PA, 19103, US

(21) Appl. No.: 10/561,716

(22) PCT Filed: Jun. 23, 2004
(86) PCT No.: PCT/FR04/01573

§ 371 Date: Mar. 7, 2006

(30) Foreign Application Priority Data
Jun. 23, 2003 (FR) 03/50247

(51) Int. Cl. A23B 4/14

(52) U.S. Cl. 99/516

(57) ABSTRACT

The present invention relates to a device for the distribution of a liquid or viscous product in order for it to be retrieved with a tool or by the hand of a user, comprising a reservoir (1) for containing this product and emptying in a distribution zone (2, 7) for the retrieval of this product, characterized in that the distribution zone (2, 7) comprises openings for preventing the product from exfiltrating in the absence of an action by the user, and in that the reservoir (1) is placed under an excess pressure that is determined as a condition of the use at a value less than the pressure that causes the seeping of the product when the device is at rest, which pressure is, moreover, sufficient to bring about the exfiltration of the product onto the distribution zone (2, 7) when the user exerts an action on this distribution zone (2, 7).

### RELATED APPLICATION

This is a §371 of International Application No. PCT/FR2004/001573, with an international filing date of Jun. 23, 2004 (WO 2005/000710 A2,published Jan. 6, 2005), which is based on French Patent Application No. 03/50247, filed Jun. 23, 2003.

### FIELD OF THE INVENTION

This invention relates to a device for the distribution of a viscous or liquid product, especially a washing product, that allows the product to be retrieved (collected) on a distribution surface.

### BACKGROUND

WO 00/30519 describes a device for dispensing washing product, in particular, for washing dishes, constituted of a solid or solidified washing product with means for connecting to a support and a surface designed to allow the retrieval of a surface sample of the washing product with the aid of a washing instrument.

That device is adapted for solid or gelled products with an inherent (natural) consistency. It is not adapted to the distribution of liquid or viscous products.

There are other proposed solutions for the distribution of liquids.

For example, EP 753 466 describes a device for conditioning and distributing a liquid, gelled or pasty product such as a cosmetic product, comprising a reservoir suitable for containing the product and for being placed under pressure for distributing this product. It comprises an applicator in the form of a dome communicating internally with the reservoir and provided with exit orifices for the product to be distributed. The product flows out via the exit orifices by the product being placed under pressure upstream from these orifices.

The applicator comprises an elastic external membrane for application of the product on a large surface such as the skin, traversed by orifices for distribution of the product, and an internal support wall on which the membrane rests when the product is not being placed under pressure for its distribution, which internal support wall comprises feed orifices offset relative to the distribution orifices in such a manner that the external membrane isolates, when it is at rest, the feed orifices from the outside. Moreover, the external membrane can separate elastically from this internal support wall under the effect of the pressure of the product for the distribution to permit flow of the latter from the feed orifices toward the distribution orifices and exiting of the product from the applicator.

According to that solution, the internal excess pressure separates the two membranes and thus causes the liquid, gelled or pasty product to flow. There is therefore an outflow of the product as long as the membranes are separated, which is a significant problem in the case of a device for the distribution of a viscous or liquid product, in particular a washing product. More-over, that solution implies that the distributor is held with one hand, that a pressure is exerted on it for extracting the liquid that it contains and placing it on a tool held with the other hand, which prevents the object to be cleaned from being held at the same time.

Thus, one ends up with manipulations that are not very ergonomic and oblige one to put the article down to be cleaned, to grasp the product distributor, on which a pressure is to be exerted with one hand, to approach the cleaning tool on which the washing product is to be placed and that is held by the second hand, and to then put the distributor down before being able to grasp the article to be cleaned.

U.S. Pat. No. 6,030,138 relates to a sintered, porous, polymeric material that can be used as the applicator surface of a distributor if this material is molded by insertion into a relatively rigid, substantially non-porous frame. This material should be flexible and have a thickness less than approximately 0.15 cm. Due to the fact that it is molded by insertion into a relatively rigid, substantially non-porous frame, the gel or lotion is distributed at the level of a more central part of the applicator surface, which prevents a distribution on the edge, which would bring about a wasting and clogging of the surface of the recipient. Moreover, due to use of a rather thin part of the sintered, microporous, polymeric material connected to a relatively non-porous frame, the flexibility of that material is increased and its resistance to chock is elevated. The distribution is also facilitated by virtue of the reduced thickness of the sintered, microporous, polymeric material.

That solution is not totally satisfactory either. The porous material is permeable in both directions and quite particularly from the outside toward the inside. This brings about a pollution of the product contained in the distributor. Moreover, this solution can not be used in the case of viscous liquids such as the dishwashing product because the product obstructs the membrane pores.

### SUMMARY OF THE INVENTION

This invention relates to a device for distributing a liquid, viscous or pasty product for retrieval with a tool or by a user, including a reservoir for containing the product and emptying in a distribution zone for retrieval of the product, wherein at least a part of the device upstream from the distribution zone is placed under excess pressure and the distribution zone includes openings for preventing the product from exfiltrating in the absence of an action by the tool or user, which excess pressure is adjusted as a condition of the use at a value lower than the pressure causing the using of the product when the device is at rest, which pressure is also sufficient to cause exfiltration of product on the distribution zone when the user exerts an action on the distribution zone.

### BRIEF DESCRIPTION OF THE DRAWINGS

The invention will be better understood from a reading of the following description that makes reference to the attached drawings corresponding to non-limiting exemplary embodiments in which:

FIGS. 1 and 2, respectively, are a perspective view and an exploded view of a first exemplary aspect of the invention;

FIGS. 3 to 10 show sectional view of different aspects of the slits;

FIGS. 11 and 12 are sectional view of the distribution zone in two difference positions

FIG. 13 shows a front elevational view of a second aspect of the invention;

FIG. 14 shows a sectional view of a third aspect of the invention;

FIGS. 15 and 16 show sectional views of a fourth aspect of the invention;

FIG. 17 shows a perspective view of a fifth aspect of the invention;

FIGS. 18 to 21 show views according to a sectional plane passing through axis AA of FIG. 17;

FIGS. 22 and 23 show sectional views similar to those of FIGS. 18 and 19 in accordance with a sixth aspect of the invention;

FIGS. 24 and 25 show a sectional view of yet another aspect of the invention;

FIG. 26 shows a sectional view of a variant of a membrane supported on a rigid perforated plate;

FIG. 27 shows a sectional view of a membrane comprising a network of partitions that render it rigid;

FIG. 28 shows a sectional view in which the body comprises a bottle pourer;

FIG. 29 shows a perspective view in which the distribution zone comprises a bottle pourer;

FIGS. 30 to 32 show perspective view in which the body containing the product cooperates with a base;

FIG. 33 shows a perspective view, partially taken in section, of another aspect of the invention;

FIGS. 34 to 36 show varying views of a flexible membrane; and

FIGS. 37 to 39 show three other views of aspects of the invention.

### DETAILED DESCRIPTION

This invention provides in a general sense a device for distributing a liquid, viscous or pasty product to be retrieved with a tool or by the hand of a user, comprising a reservoir for containing the product and emptying in a distribution zone for the retrieval of the product, characterized in that the distribution zone has openings determined in such a manner as to prevent the product from filtering out in the absence of an action by the user and that the reservoir is placed under an excess pressure that is determined as a condition of the use at a value less than the pressure that causes seeping/oozing of the product when the device is at rest, which pressure is, moreover, sufficient to bring about the exfiltration of the product onto the distribution zone when the user exerts an action on this distribution zone.

The distribution zone or retrieval zone is a surface on which the product is delivered and rendered accessible for being retrieved by a tool, even by the fingers of the user.

The reservoir can be constituted of one or several compartments emptying onto the distribution zone. When it is composed of several compartments, it permits delivery of multi-phase products constituted, e.g., of different components to be mixed during their use. The mixture is then made on the distribution zone. In the case of several compartments or several reservoirs, each of the compartments or reservoirs will be placed under an excess pressure.

The atmospheric pressure acting on the product in the reservoir generates an excess pressure between the inside and the outside of the retrieval zone by virtue of the gravity of the product. It preferably comprises a means for placing the reservoir under a permanent pressure greater than atmospheric pressure.

The term “placing under permanent pressure” means that the reservoir is subjected to a pressure greater than the atmospheric pressure not only when the device for distributing the product that it contains is used, but also during rest, and that the excess pressure prevails in the reservoir during a lapse of time greater than the period of use. This does not concern an excess pressure exercised only at the moment at which the attempt is made to extract a quantity of liquid contained in the reservoir. For this, it is therefore necessary that the reservoir is closed by a distribution zone that ensures a certain tightness at rest and only allows the liquid (or air) to pass when an action is exerted on the distribution zone. The excess pressure alone is not sufficient to open the distribution zone.

The means for placing under pressure may be constituted of a piston. The piston may be loaded by a weight exerting a vertical force on the piston. The piston may also be subjected to the action of a spring supported on an adjustable base to adjust the pressure exerted on this piston. The piston may also be subjected to the action of a base adjustable by a manual pressure to adjust the excess pressure exerted by this piston. The means for placing under pressure may be constituted of a part of the reservoir with a variable volume subjected to the action of a force for placing under tension. The part of the reservoir with a variable volume may be formed by a bellows.

The means for placing under pressure may also be constituted of the product column and the distribution zone may be situated in the lower part of the reservoir.

The three latter alternatives allow pressure drops resulting either from extraction of a quantity of product or simply from the imperfect tightness of the distribution zone at rest to be compensated. The distribution zone preferably has at least one slit whose dimensions are determined in such a manner as to prevent the exfiltration of products in the absence of an action on the surface of this distribution zone.

The distribution zone advantageously has a plurality of slits. The slits may form a multidimensional network.

The slits may also form angles between 60 and 80 ° with the outer surface of the distribution zone. This orientation is advantageous because the slits are constrained to come into a position of closure under the effect of the excess pressure prevailing in the reservoir. The slits may also have an elongated form completed at each end by punching with a greater width than that of the elongated segment.

The slits may be formed at the top of protuberances. The protuberances are preferably constituted of slit hemispherical domes. The protuberances may be constituted of slit lamellae. The slits may also be formed between two consecutive protuberances.

The distribution zone is preferably formed at the lower part of the liquid and obturates the product reservoir at rest. It can advantageously be provided with a flexible valve that keeps the product from drying out while allowing air to reenter when a low pressure appears in the bottle as a consequence of retrieving product on the distribution zone. The distribution zone may have a valve effect.

The distribution zone may comprise a conduit formed between two membranes of which at least one is flexible.

Aspects of the invention will be described in the following text with reference to the drawings for a particular application, namely, the distribution of dishwashing product.

For washing dishes in running water, the objects to be washed, the brush or sponge and the dishwashing liquid, usually in a liquid form in a simple bottle, must be manipulated. The major ergonomic problem is that one has only two hands for manipulating three objects, which causes numerous manipulations that are not very rational, such as changes of the hands.

The invention relates to a device that permits the retrieval on its surface of a more or less viscous liquid product, in particular liquid for washing dishes manually. This device readily permits retrieval of a precise dose of product simply by applying its tool on it. The retrieved amount of the substance should be a function of the pressure and of the width/extent of the movement on the surface.

The distributing device is placed in a stable manner or firmly fixed, e.g., on the edge of the sink for a dishwashing liquid. It comprises the following main constituent elements:
One or several product reservoir(s),
An outflow zone controlled by pressure or deformation that closes the reservoir at rest.

It strives for the following effects:
Absence of seepage: The liquid should not seep through the outflow zone,
Distribution: The liquid should flow out when the outflow zone is stimulated by applying a tool on it that is to be charged with product (brush, sponge, etc.) or a surface on which a coating is to be realized (skin, leather, wood, etc.).
Barrier: If another liquid comes in contact with the outflow zone (e.g., water introduced by a wet sponge), this latter liquid should not penetrate into the enclosed area in order to not contaminate the liquid contained in the reservoir.

Note that the effect of distribution is relatively in contradiction with the two other points and all the more if it is desired:
That the retrieval of a dose can be made in an instantaneous and intuitive manner,
In a relatively consequent quantity (in the case of dishes, the average dose is rather significant-on the order of 0.1 ml).

The solution proposed is an outflow zone behind which the liquid is maintained with a slight excess pressure that is not sufficient to cause the liquid to traverse the outflow zone, but under the action of the tool used to do the dishes the outflow zone is deformed, which has two consequences that may be combined:
A supplementary excess pressure in the volume that releases the escape via the outflow zone,
Deformations of the outflow zone that augment or actuate the opening of the out-flow zone and cause the escape.

Note that the difference of pressure allows the liquid to be always available, backed up behind the outflow zone. Then, a liquid coming from the outside has no tendency to cross the outflow zone.

FIGS. 1 and 2 show a first exemplary embodiment. The device is constituted of a cylindrical reservoir 1 consisting of rigid plastic closed by an elastic membrane consisting of an elastomere 2 whose outer surface forms the distribution surface. This membrane 2 is cut in a compact rubber film with a density of 1.5 and a hardness of 60 Shore A and a thickness of 0.7 mm and has radially oriented slits 3. Each slit or cut 3 has a length of 4 to 5 mm.

Membrane 2 is fixed on reservoir 1 with the aid of ring 100 with annular peripheral shoulder 101 that ensures tightening of the membrane on reservoir 1. The upper part of the reservoir is closed by front cover 103 comprising orifices 102. Membrane 2 comprises incisions or slits 3. When cover 103 is superposed on membrane 2, the zone with slits 3 on membrane 2 and the zone with orifices 102 of cover 103 are preferably different. When there is in excess pressure in the reservoir the membrane is curved (convex). When there is no longer an excess pressure, e.g., because all the liquid causing the curve (convexity) has been retrieved, the membrane becomes flat again.

It then preferably rests on a solid, rigid zone that allows the user to visualize the fact that the user must re-create an excess pressure if there is a desire to continue retrieving product. This solid, rigid zone also allows the user to be prevented from continuing to retrieve liquid that might create air pockets that might cause water or contaminants to re-enter into the recipient.

The position of the membrane can also be brought about by the user by voluntarily and provisionally suppressing the internal excess pressure during the periods of non-use. The position is then suitable for a stable storage since the exchanges between the interior and exterior are then limited, in particular if the solid, rigid zone covers all the membrane zone comprising the slits.

Reservoir 1 is provided with a piston 4 sliding in a tight manner in the reservoir body, whose lower end forms an outer casing (shell). The piston allows the inner volume of the reservoir to be put under pressure and the pressure to be adjusted when the excess pressure diminishes. This excess pressure allows the penetration of air or foreign liquids into the reservoir to be prevented.

As an option, an inner, elastic membrane separates the first part of a cylindrical body in which the piston is housed from the complementary part forming the product reservoir. The former part forms an outer casing that allows the second part containing the product to be distributed to be put under pressure. The piston does not make direct contact with the product to be distributed, that is put under pressure via the internal membrane on which the pressure of the air compressed inside the first part is exerted.

The excess pressure can be realized in the various possible configurations by:
1) A piston moved by a pressure screw.
   A pressure screw creating a piston effect comparable to the functioning of known glue sticks or deodorant sticks.
2) A piston moved by the intrinsic (inherent) weight of the upper part of the device.
3) A manually moved piston.
4) A pump whose piston is actuated by a plate whose upper surface forms the product distribution zone. One presses on the surface of the plate, e.g., when retrieving product to increase the excess pressure, which brings about an excess pressure in the reservoir and therefore makes product available on the retrieval zone.
The same device can also function with a brake between the outer casing and the piston. Increasing the pressure is performed manually via a grasping zone.
A bladder can be placed in the upper chamber that will be compressed in accordance with the use to limit problems of tightness in the two latter instances.

5) A flexible pocket or an accordion.
The pocket or the accordion collapses onto itself.

6) A pressure obtained by gravity.
The distribution zone is situated at the foot of the bottle. The column of liquid creates an excess pressure that is very slight but sufficient for properly backing up the liquid behind the membrane. This solution has the disadvantage that the end of the bottle is difficult to access.

7) A pressure generated in an intermediate chamber.
A deformable zone, or more simply, the bottle itself, allows an excess pressure to be created in the recipient and the liquid to be sent into a chamber position directly under the outflow zone via a plunger tube communicating between the two chambers.
While filling the chamber positioned under the outflow zone the latter also rises in pressure.
A small valve that keeps the liquid from re-descending is located at the end of the plunger tube.
In order that the bottle returns to the atmospheric pressure the air penetrates into the recipient via a valve or more simply via escapes (leakage ports) at the level of the juncture between the chambers.

The characteristics of the membrane, slits and the importance of the excess pressure are functions in particular of the nature of the product to be distributed and of the material constituting the membrane forming the retrieval zone. One skilled in the art may determine these characteristics by successive trials, varying the characteristics and confirming the result obtained.

The dimensions can be confirmed, resulting in an absence of exudation of the product at rest and in a delivery of the product contained in the reservoir when a pressure is exerted on the membrane surface by successive experiments. This is a matter of routine tasks that are performed, e.g., by taking a series of non-perforated membranes with a selected geometry, type and thickness in which slits of an increasing length are made with a constant increment. The curve representing the volume of product exuded during a reference time, e.g., 24 hours, when the experimental device is put down and allowed to rest is established with an internal excess pressure type. The value L1 of the length of the slits from which the exuded volume is non-negligible is noted.

Likewise, the curve representing the volume of the product delivered during the exerting of a reference pressure with a sample tool during a reference time, e.g., 0.5 second, is established. The value L2 of the length of the slits from which the exuded volume is measurable is noted.

The optimal dimensions will be less than L1 and greater than L2. One skilled in the art can choose to fix the length of the slits at a constant value L to act only on the topography of the membrane or on its thickness or also on the elasticity or the flexibility of the membrane material to perform these experimental routine tasks.

The curved or inclined shape of the distribution zone constitutes an advantage to avoid the stagnation of water added by the tool for the retrieval of the product.

The slits can assume numerous shapes:
buttonhole shape with a longitudinal segment and two widened-out zones at the end of this segment.
An elliptical shape, in particular for very viscous products.
An inclined transversal plane (that is, one intersecting the surface of the distribution zone).
An arrangement in a network of slits radiating radially or according to an organized matrix.

The shape can be formed by cutting a plane membrane or also be formed at the top of protuberances, e.g., at the top of an elongated dome or also of a pleat in the membrane (FIGS. 3 and 4) with the adjacent sides of the membrane then forming types of lips 105, 106 or also at the top of hemispherical domes 110 shown in FIG. 5 and distributed on membrane 2 as shown in FIGS. 5 and 6.

They can also be formed in troughs of an undulated surface (FIGS. 7 and 8). Membrane 2 has a series of protuberances with a formation of convex or projecting lips 110, 120 extending via concave or reentering lips 111, 121. Reentering lips 111, 121 link up tangentially along median plane 122 where they are separated by slit 3. This topography has the advantage that the internal excess pressure tends to close the passage zone and limit the outflow as long as there is no mechanical stimulation of the retrieval zone. The two lips converge tangentially and link up along a contact plane substantially perpendicular to the surface of the distribution zone. When a tool is put on the distribution zone, these two lips are slightly deformed and their opening is brought about, thus permitting the outflow of the contents under a slight excess pressure. In contrast thereto, when at rest, the elasticity of the material constituting flanges and lips ensures their closure with a force sufficient to avoid an exfiltration of the contents of the reservoir.

The slits can also be preceded by reliefs 6 as shown in FIGS. 9 and 10. These reliefs 6 are, e.g., flanges with a triangular section placed along slits 3 in front of the slits when considering the direction 130 of the movement of the retrieval tool. The tool stops against reliefs 6, which brings about a slight deformation of the flexible membrane in the proximity of the adjacent slit 3, which brings about the opening of the slit and releases the product that the reservoir contains under the effect of the excess pressure prevailing in it.

The membrane traversed by slits has a concave shape prior to assembly as shown in FIG. 11. During assembly and use, it has a convex shape as shown in FIG. 12, which forces the closure of the slits.

FIG. 13 shows a cylindrical body 1 forming a reservoir and emptying in its lower part on retrieval zone 7 that communicates with the reservoir via a distribution zone that opens when one presses on the retrieval zone.

FIG. 14 shows membrane 2 placed on plate 150 integral with pump 151. This pump is, e.g., a pump that is used for manual aerosols and creates a flow of air that places the reservoir under pressure when an axial action is exerted on plate 150. That pressure causes the product to rise in tube 150 extending into reservoir 1 and causes it to bubble/rise to the surface of membrane 2. Plate 150 is hollow. The cavity constitutes a buffer reservoir containing product to be distributed. The product is exfiltrated when an action on the surface of the plate presses it down and actuates pump 150 for placing the reservoir under pressure or when the membrane is deformed and generates a local excess pressure and a deformation that brings about the exfiltration of product by itself.

Alternatively, the pump can also draw the liquid directly into the recipient and cause it to rise up in the distributor plate, which achieves a relatively equivalent operation.

FIGS. 15 and 16 show a sectional view in which reservoir 1 placed under excess pressure opens onto distribution surface 2 via two planes 160, 161 adjacent at rest.

One of the plates, 161, is flexible and extends distribution zone 2. When a pressure is exerted on distribution zone 2 with a retrieval tool, flexible plate 161 is slightly deformed and separates from fixed plate 160 of reservoir 1. It then forms a slight interstice that permits exfiltration of the product under excess pressure contained in reservoir 1. Optional valve 162 facilitates outflow of the liquid. It is closed when the two plates 160, 161 are coupled under the effect of the return to the initial geometric configuration due to the memory of the shape of the plastic materials used, e.g., PET.

FIGS. 22 and 23 show a sectional view in which reservoir 1 placed under excess pressure by the effect of the liquid product column opens onto distribution surface 2 via a passage formed between two planes 160, 161 adjacent at rest. Upper plane 160 belongs to reservoir 1 and lower plane 161 belongs to shoe 170 coupled under reservoir 1 and extended by retrieval zone 7 (neither 2 nor 7 are shown in those figures). When pressure is exerted on retrieval zone 7 with a retrieval tool, plate 161 is slightly deformed and opens a passage between planes 160, 161 that permits exfiltration of the product under excess pressure contained in reservoir 1. This interstice is closed when the two plates 160, 161 are coupled under the effect of the return to the initial geometric configuration due to the memory of the shape of the plastic materials used, e.g., PET, that tends to push flexible plate 161 of shoe 170 back against plate 160 of reservoir 1.

FIGS. 17 to 21 show that the distribution of the liquid takes place via deformable conduits 160 to 162 emptying onto distribution zone 2. Reservoir 1 is placed vertically above distribution zone 2. Deformable conduits 160 to 162 are closed when at rest at their ends by a pinched slit. When a tool 165 approaches (FIG. 18) distribution zone 2, the latter makes contact with at least one of the conduits 162.

When a pressure is exerted (FIG. 19) on conduit 162 with tool 165, conduit 162 is squeezed and the product that it contains is forced in two opposite directions, which creates a slight excess pressure in the downstream segment that tends to open the lips formed at the end of conduit 162.

Tool 165 is then placed in the direction of the end of the conduit (FIG. 20), which causes the transport of a mass of product in the direction of the end of conduit 162. When tool 165 reaches the end of the conduit (FIG. 21) it collects the quantity of product extracted on the occasion of this manipulation.

FIGS. 24 and 25 show that upper membrane 2 has slits of the type described for FIGS. 9 and 10, each one with a length of 12mm. Membrane 2 is realized of material that is deformable, but only slightly extensible, e.g., of compact rubber with a density of 1.5 and a hardness of 60 Shore A and a thickness of 1 mm.

The material of lower membrane 180 closing the piston is selected to be quite elastic, e.g., of latex. The pressure is adjusted in the reservoir by compressing piston 175 under visual control until the liquid beads through slits 3 of the upper membrane. The deformation generated on the lower membrane procures a reserve of available liquid that will be mobilized during the next actions of the tool on the upper membrane.

This configuration has the advantage of using an upper membrane that is only slightly elastic while providing a reserve of following liquid.

The device should be able to resist mechanical stimulations of the retrieval zone without falling over and while moving as little as possible. It is therefore preferably stocky with a large base and not very high. Its sole preferably consists of a non-skid material or is provided with ballast, an adhesive or a suction cup. It can be placed on the edge of the work plane or fixed to the wall with the aid of an adhesive or a screw.

A flared cup (cap) can be located around the retrieval zone. This cup can be designed to leak to avoid retention of water on the retrieval zone. The retrieval zone can carry small reliefs that ensure a certain retention of the liquid and stimulate the foam. It can be provided that the outflow zone is blocked by an adhesive to avoid any outflow prior to usage (storage, transport display, etc.). The outflow zone can be closed by a tipping or removable hood.

In certain situations, it is of interest to be able to pour liquid. Thus, the presence of a customary pourer is advantageous or the possibility of forcing the outflow of the liquid via the outflow zone, e.g., by strongly compressing the recipient or strongly actuating the piston.

The device can be a package of disposable dishwashing product. It can be a mini-dose dose of disposable dishwashing product (like cartons of household products). It can be a permanent manent product intended to be refilled.

The preceding description was formulated for dishwashing products, and that is the main market addressed herein. However, the solution can be applied to many other areas, and in particular:

Domestic applications:
Creams, especially creams for body care, shaving gels, epilation waxes, sunscreen lotions,
Shower gels, shampoos and liquid soaps,
Wax or liquid wax (polish) for rags,

Industrial applications:
Placing oil or glue on an applicator or on a piece.

Agrofood applications:
Delicacies, paste spreads, etc.

Furthermore, it is possible to envision that these solutions are used for applicators. The entire product is then taken in the hand for applying the liquid on a surface (waxing, oil on a cake mold, liquid or gel deodorant or also body cream, etc.).

The invention can result in other constructions such as described below.

FIG. 26 shows a sectional view wherein the membrane rests on a rigid perforated plate. Distribution zone 2 comprises flexible membrane 200 forming hemispherical protuberances 210 slit by slit 220. Membrane 200 rests on rigid perforated plate 250 comprising orifices 260 opening on hemispherical protuberances 210. The section of orifices 260 corresponds substantially to the section of hemispherical protuberances 210.

This prevents the flexible distribution zone from collapsing under the pressure of the tool or of the hand. It permits optimizing the performances of the membrane required for ensuring an obturation of the slits and an opening under the pressure of a hand or a tool for the distribution of the content.

Alternatively, a similar effect can be obtained by creating a network of partitions 230 under the membrane that rigidify it as shown in FIG. 27. The membrane is then constituted of a thick structure with hemispherical protuberances 210 opening by distribution slits 220, and semi-rigid rigid intercalary zones with, e.g., a honeycomb structure.

FIG. 28 shows a structure in which the body comprises a bottle pourer. The bottle pourer may be provided at the top end of the bottle. When the plug is open it permits a direct usage by outflow and also permits the introduction of air in proportion to the retrieval of the product on the distribution zone.

It can advantageously be provided with a flexible valve that prevents the product from drying out, while allowing air to reenter when a partial vacuum appears in the bottle due to the retrieval of product on the distribution zone.

FIG. 28 shows another construction comprising bottle pourer 270 located under or at the bottom of the bottle. It is necessarily obturated in a tight manner. It is advantageously provided with pushbutton closure 270. In this configuration, admission of air into the volume of the reservoir is made at the level of the distribution zone itself.

FIG. 29 shows bottle pourer 270 belonging to distribution zone 2 and made from the same material. Bottle pourer 270 remains obturated when the internal pressure is low and opens when the internal pressure is strong, in particular when the user's hand exerts a direct and significant compression on the bottle body.

FIG. 30 shows the distribution zone provided with shoe 280 and forms a volume independent of bottle 281, that forms, for its part, the reserve. When the bottle is connected to shoe 280, distribution zone 2 is supplied. The bottle opening is advantageously provided with a valve so that the bottle can be connected to and be connected from the shoe without loss of product.

FIGS. 31 and 32 show the bottle formed by a hollow volume and a plug. When it is set on the shoe, it is perforated by hollow needle 282 forming a tube, located on the shoe. The liquid in the bottle then reaches the distribution zone.

The bottle can be a flexible container like that of a carton of milk or a type like plug cartons of the Doy-Pack type (stand-up, custom-printed pouches, of Chinese origin - http://www. biztee.com/Products/1339.html).

FIG. 33 shows the product contained in flexible or accordion-type pocket 290. This flexible pocket can be a flexible bag enclosed in a non-tight hollow volume (bag in-the box type). The retrieval zone is then advantageously treated with the plug or added, especially by welding, onto one of the faces of the bag.

To permit the obtention of different sensations and different distribution conditions, the membrane or, more generally, the distribution zone, is provided with exterior reliefs like fibers, deposited in particular by flocking (flock spraying) or pitting (chipping, stitching), like lamellae, foam or grains immersed in the mass.

FIGS. 34 to 36 show various membranes utilizing flexible reliefs in boss beadings.

FIGS. 34 and 35 show that the conduits can be obtained by flexible reliefs in boss beadings placed on a more rigid surface to create the effect of a roller pump already present in the structures shown in FIGS. 17 to 21.

FIG. 36 shows the reliefs obtained by forcibly removing a flexible material, especially a thick elastomere, from the mold, then by creating the exit slit for the liquid by cutting. Altenatively, the general form of the distribution zone can be inclined, forming a hollow fold.

FIG. 37 shows a specific plug or laminated (plasticized) adhesive 295 provided and obturating the zone to render the distribution zone tight, in particular during the transport between the filling of the bottle and its use and between two periods of use.

To facilitate placing the adhesive, the distribution zone can be located in an inside recess or encased (boxed-in) zone that permits the adhesive to be applied in spite of the reliefs of the distribution zone.

FIG. 38 shows another structure in which pocket 300 has the general shape of a bar of soap. It is constituted of a flexible membrane having, at least partially, retrieval surface 2.

The pocket can be realized of an elastic membrane, e.g., an elastomere. Retrieval surface 2 is formed by molding or surface treatment.

FIG. 39 shows an alternative in which the pocket is elongated and fixed between the bottom and the top of a package. The pocket is emptied by a progressive mechanical action, e.g., a wheel that causes the progression of a carriage that pinches the pocket, thus evacuating its contents into a buffer zone closed by distribution zone 2.

1-46. (canceled)

47. A device for distributing a liquid, viscous or pasty product for retrieval with a tool or by a user, comprising a reservoir for containing the product and emptying in a distribution zone for retrieval of the product, wherein at least a part of the device upstream from the distribution zone is placed under excess pressure and the distribution zone comprises openings for preventing the product from exfiltrating in the absence of an action by the tool or user, which excess pressure is adjusted as a condition of the use at a value lower than the pressure causing the using of the product when the device is at rest, which pressure is also sufficient to cause exfiltration of product on the distribution zone when the user exerts an action on the distribution zone.

48. The device according to claim 47, wherein the excess pressure is constituted of atmospheric pressure acting on the product.

49. The device according to claim 47, wherein the part placed under excess pressure is formed by the product reservoir and comprises a means for placing the reservoir under a permanent pressure greater than atmospheric pressure.

50. The device according to claim 47, wherein the excess pressure is performed by a piston.

51. The device according to claim 50, wherein the piston is loaded by a weight exerting a vertical force on the piston.

52. The device according to claim 50, wherein the piston is subjected to action of a spring supported on an adjustable base to adjust pressure exerted on the piston by adjusting the pressure exerted by the spring.

53. The device according to claim 50, wherein the piston is subjected to action of a base adjustable by a manual pressure to adjust excess pressure exerted by the piston.

54. The device according to claim 49, wherein means for placing under pressure is constituted of a part of the reservoir with a variable volume subjected to action of a force for placing under tension.

55. The device according to claim 54, wherein the part of the reservoir with a variable volume is formed by a bellows.

56. The device according to claim 49, wherein the excess pressure is exerted by a product column and the distribution zone is situated in a lower part of the reservoir.

57. The device according to claim 49, wherein the excess pressure is exerted by a first part of a cylindrical body in which a piston is positioned, which first part is separated from a second part containing the product to be distributed by a flexible membrane.

58. The device according to claim 49, wherein the excess pressure is formed by a pump actuated by the product distribution zone.

59. The device according to claim 47, wherein the distribution zone comprises at least one slit whose dimensions are determined to prevent exfiltration of products in the absence of an action on a surface of the distribution zone.

60. The device according to claim 59, wherein the distribution zone has a plurality of slits.

61. The device according to claim 59, wherein the slits form a multidimensional network.

62. The device according to claim 59, wherein the slits form angles between 60 and 80 ° with an outer surface of the distribution zone.

63. The device according to claim 59, wherein the slits are formed at top portions of protuberances.

64. The device according to claim 63, wherein the protuberances are constituted of hemispherical domes.

65. The device according to claim 63, wherein the protuberances are constituted of lamellae.

66. The device according to claim 59, wherein the slits are formed between two consecutive protuberances.

67. The device according to claim 59, wherein a surface of the distribution zone comprises protuberances adjacent to the slits, ensuring an opening of the slit during rubbing on the distribution zone.

68. The device according to claim 47, wherein the distribution zone is formed at a lower part of the liquid and obturates the product reservoir at rest.

69. The device according to claim 47, wherein the distribution zone is prolonged by a deformable inner blade that comes to rest in contact with an outer blade, which outer blade is elastically mobile to allow product contained in the reservoir to exfiltrate when a pressure is exerted on the distribution zone.

70. The device according to claim 69, wherein a conduit is deformed during manipulation of means for retrieval of product to force extraction of a dose of product.

71. The device according to claim 47, wherein the distribution zone communicates with the reservoir by an inverted valve.

72. The device according to claim 47, wherein the distribution zone is placed on a plate integral with a pump that causes the product to rise in a tube extending into the reservoir.

73. The device according to claim 72, wherein the plate is hollow and a cavity constitutes a buffer reservoir, closed by the distribution zone and containing the product to be distributed, that is exfiltrated when action on a surface of the plate pushes downwardly and actuates the pump.

74. The device according to claim 47, wherein the reservoir placed in excess pressure opens onto the distribution zone via two planes adjacent at rest, one of which plates is flexible and prolongs the distribution zone.

75. The device according to claim 74, further comprising a valve for outflow ofthe liquid, which valve is closed when the two plates are coupled under an effect of memory of the shape of the materials tending to push the inner flexible plate against the outer plate.

76. The device according to claim 47, wherein the reservoir empties onto the distribution zone via deformable conduits emptying on the distribution zone, which deformable conduits are closed at ends thereof by a pinched slit when at rest.

77. The device according to claim 76, wherein the reservoir is located vertically above the distribution zone.

78. The device according to claim 47, wherein the reservoir is constituted of several compartments emptying onto the distribution zone.

79. The device according to claim 47, wherein the distribution zone comprises a flexible membrane forming hemispherical protuberances slit by a slit, which membrane rests on a rigid perforated plate comprising orifices opening on the hemispherical protuberances.

80. The device according to claim 47, wherein the distribution zone comprises a flexible membrane constituted of a thick structure with hemispherical protuberances opening via distribution slits, and by semi-rigid intercalary zones.

81. The device according to claim 47, comprising a bottle pourer located under or at the bottom of a bottle.

82. The device according to claim 81, wherein the bottle pourer belongs to the distribution zone and is made from the same material.

83. The device according to claim 47, wherein the distribution zone is provided with a shoe and forms a volume independent of a bottle that forms a reserve.

84. The device according to claim 83, wherein the bottom of the bottle is perforated by a hollow needle forming a tube, located on the shoe.

85. The device according to claim 47, wherein the product is contained in a flexible or elastic pocket.

86. The device according to claim 47, wherein the distribution zone is provided with exterior reliefs like fibers deposited by flocking (flock spraying) or pitting (chipping, stitching), lamellae, foam or grains immersed in the mass.

87. The device according to claim 85, wherein the pocket has a shape of a bar of soap and is constituted of at least one flexible membrane.

88. The device according to claim 76, wherein the deformable conduits emptying on the distribution zone are obtained by flexible reliefs in boss beadings placed on a more rigid surface.

89. The device according to claim 76, wherein the deformable conduits emptying on the distribution zone are obtained by forcibly removing a flexible material from the mold, then by creating the exit slit for the liquid by cutting.

90. The device according to claim 47, wherein the distribution zone can be closed by a plug obturating the zone to render the distribution zone tight between filling of a bottle and its use and between two periods of use.

91. The device according to claim 47, wherein the distribution zone is covered by a laminated adhesive obturating the zone to render the distribution zone tight between filling a bottle and its use.

92. The device according to claim 47, wherein the product is contained in a flexible, elongated pocket and emptied by a mechanical action in a buffer reservoir closed by the distribution zone.
